(19) United States
(12) Patent Application Publication
(10) Pub. No.: US 2024/0034166 A1
(43) Pub. Date: Feb. 1, 2024

(54) CHARGING DEVICE AND METHOD FOR CHARGING AN ELECTRICAL STORED ENERGY SOURCE OF AN ELECTRICALLY OPERABLE VEHICLE

(71) Applicants: Mercedes-Benz Group AG, Stuttgart (DE); BRUSA HyPower AG, Sennwald (CH)

(72) Inventors: Stefan SEIFFERT, Filderstadt (DE); Mark RENNER, Esslingen (DE); Matthias KRONEWITTER, Esslingen (DE); Andreas RODEWALD, Herrenberg (DE); Ottmar SCHMID, Markdorf (DE); Hannes HOBI, Walenstadt (CH); Marc HANSELMANN, Frümsen (CH)

(21) Appl. No.: 18/258,684

(22) PCT Filed: Dec. 21, 2021
(86) PCT No.: PCT/EP2021/087128

§ 371 Date: Jun. 21, 2023

(30) Foreign Application Priority Data
Dec. 21, 2020 (DE) 10 2020 007 865.6

(51) Int. Cl. B60L 53/22; H02J 7/00

(52) U.S. Cl. CPC B60L 53/22; H02J 7/0068; B60L 2210/10

(57) ABSTRACT

The invention relates to a charging device (100) for charging an electrical stored energy source (60) of an electrically operable vehicle (200), said charging device comprising: a charging connection (50) for electrically connecting the charging device (100) to an external voltage supply; a charging unit (10) for converting a first DC voltage applied to the charging connection (50) into a second DC voltage which is provided for charging the electrical stored energy source (60); and a power distributor unit (30) having a first and a second output (36, 38) for providing the first DC voltage applied to the charging connection (50) and/or the second DC voltage converted by the charging unit (10) to the electrical stored energy source (60) connected to the outputs (36, 38). The power distributor unit (30) has: a first electrical connection (52) for the charging connection (50); and a second electrical connection (56) for the charging unit (10). The invention also relates to a method for charging an electrical stored energy source (60) of an electrically operable vehicle (200) using such a charging device (100).

### FIELD

The invention relates to a charging device for charging an electrical energy storage of an electrically operable vehicle as well as to a method for charging an electrical energy storage of an electrically operable vehicle with such a charging device.

### BACKGROUND

If the existing high-voltage on-board power supply architecture of an electrically operable vehicle is based on 800 V on-board power supply voltage, an additional 400 V/800 V DC voltage converter is required for charging the electrical energy storage of the vehicle at a 400 V charging station.

DE 102019003459 A1 discloses a charging device for charging a high-voltage battery with a DC voltage connection for connecting the charging device to an external charging connection. The charging device includes an AC voltage connection for connecting the charging device to a second external charging connection and to a DC voltage converter for converting a first DC voltage of the first charging connection into a second DC voltage, with which the high-voltage battery is supplied. The charging device also includes an on-board charger for converting an AC voltage of the second charging connection into the second DC voltage, wherein the first DC voltage can be converted into the second DC voltage higher with respect to the first DC voltage by a parallel connection of the DC voltage converter and the on-board charger. The charging device is a charging unit of an electrically operable vehicle, with which a high-voltage battery of the electrically operable vehicle can be charged. By the parallel connection of the DC voltage converter and the on-board charger, a lower DC voltage of the first external charging connection with respect to a battery voltage of the high-voltage battery can be converted into the second DC voltage.

Such DC voltage converters (also called DC/DC converters) are already known in the power electronics for a long time and in diverse manner, also in the interconnection of the components itself, and for example also described in the literature in the book “Grundkurs Leistungselektronik” by Joachim Specovius in the 3^{rd} edition from the year 2009 in the chapter 18 “Gleichspannungswandler”. Herein, one can still divide the DC voltage converters into buck converters, boost converters and buck-boost converters. A boost converter illustrated there is for example designed as a so-called half-bridge converter, in which the voltage is continuously applied from the input up to the output in substantially unchanged manner at a first pole and the voltage is converted from the input with a lower voltage to the output with a higher voltage at the second pole by the components and corresponding circuits. A so-called charge pump can also serve as a boost converter, which is also referred to as charge doubler due to a fixed conversion ratio of 1:2 and is also known to the expert from the general prior art. In the DC voltage converters, there is the possibility for all types, in particular in galvanically coupled DC voltage converters, to select a design of the DC voltage converter, in which the voltage level precisely is directly coupled at a pole between input and output and thereby is invariable such that the voltage level between the input and the output is then changed and thus converted at the other pole.

### SUMMARY

It is an object of the invention to provide an improved charging device for charging an electrical energy storage of an electrically operable vehicle.

It is a further object to specify a method for charging an electrical energy storage of an electrically operable vehicle with such an improved charging device.

The above mentioned objects are solved by the features of the independent claims.

Beneficial configurations and advantages of the invention are apparent from the further claims, the description and the drawing.

According to an aspect of the invention, a charging device for charging an electrical energy storage of an electrically operable vehicle is proposed, comprising a charging connection for electrically connecting the charging device to an external voltage supply, a charging unit for converting a first DC voltage applied to the charging connection into a second DC voltage, which is intended for charging the electrical energy storage, as well as a power distributor unit with a first and a second output for providing the first DC voltage applied to the charging connection and/or the second DC voltage converted by the charging unit to the electrical energy storage connected to the outputs. Therein, the power distributor unit comprises a first electrical connection for the charging connection and a second electrical connection for the charging unit. The power distributor unit comprises switches, by which the charging connection is switched to the first and the second output in a first charging state, and a first output of the charging unit is switched to one of the outputs of the power distributor unit and a second output of the charging unit is switched to the other one of the outputs of the power distributor unit in a second charging state.

According to the invention, in the charging device, the first DC voltage of the charging connection can be switched to the first and the second output of the power distributor unit in the first charging state, and the second DC voltage converted by the charging unit can be switched to the first and second outputs of the power distributor unit in the second charging state. In the first charging state, the energy storage, which is connected to the outputs of the power distributor unit and which for example has 800 V rated voltage, can be directly charged via a DC voltage applied to the charging connection of also 800 V. In the second charging state, if only a first DC voltage of 400 V is for example provided at the charging connection, this first DC voltage can be converted to a second DC voltage of 800 V by the DC voltage converter of the charging unit and thus the energy storage can also be charged with 800 V.

According to the invention, in the charging device in the second charging state, in particular in which the first DC voltage at the charging connection is less than the rated voltage of the electrical energy storage, the first output of the charging unit can also be interconnected to a first pole of the charging connection via the first switch of the power distributor unit as well as directly to the first output of the power distributor unit. Therein, the second output of the charging unit can be interconnected to the second output of the power distributor unit, and an input of the charging unit can be interconnected to a second pole of the charging connection. Therein, a switch is provided in the charging unit, which interconnects the input of the charging unit to an input of a DC voltage converter of the charging unit. Herein, the first output of the charging unit is also used as an input of the charging unit at the same time by a connection of the first output of the charging unit to an output capacitance and an input capacitance. With this convenient interconnection, the first DC voltage can be interconnected to the charging unit, converted into the second DC voltage and this second DC voltage can be interconnected to the outputs of the power distributor unit. Therein, only a three-pole line set for connection between power distributor unit and charging unit is advantageously required. Advantageously, the charging unit of the charging device according to the invention is not arranged between the charging connection and the power distributor unit and thus comprises two inputs and two outputs as in the prior art, but can be connected from the power distributor unit and only requires three connections thereto. Thereby, a direct connection between the charging connection and the power distributor unit is correspondingly possible. This corresponds to the function of a bypass circuit of the charging unit, wherein it is then no longer effected via the charging unit. The power distributor unit contains all of the further components relevant to charging as well as components of a so-called high-voltage intermediate circuit with for example components for connecting the energy storage to the high-voltage on-board power supply. The charging unit can comprise a default DC voltage converter, which is formed as a step-up converter such that an electric vehicle (EV) with a high-voltage on-board power supply with higher voltage, for example 800 V, can also be charged at a DC charging station with lower voltage, for example 400 V.

Especially in contacting and in the line set, especially in high-voltage lines, the interconnection of the charging device has advantages. With the charging device according to the invention, the same functions can be realized as in a usual charging device, and a direct connection between charging connection and the power distributor unit can nevertheless be used in simple charging with direct current (DC), in which the charging voltage corresponds to the system voltage of the on-board power supply and of the energy storage, respectively. Therein, the charging unit is not loaded. The charging current either is not guided via the charging unit, which simplifies the line set, requires less contact pads and thus is also better in heat development and cooling.

In the charging device according to the invention, the charging unit is advantageously integrated in the existing high-voltage on-board power supply architecture with a DC voltage converter as a galvanically coupled converter. Therein, in charging an 800 V energy storage at a 400 V charging station, the serial charging path of the charging device can be left open by a present switch such that the first DC voltage of 400 V of the charging station can be applied to the input side of the charging device and 800 V of the DC voltage converter are available for charging the energy storage at the output of the power distributor unit. Herein, the values of 800 V and 400 V are of course example values for clarifying the benefits and advantages of the invention and, as is also known to an expert, they are not fixed values, which are permanently applied, but depend on the charging state of the energy storage or on the charging station and are in a wide voltage band, which is symbolized by these values.

With such a charging device, additional DC contactors for a bypass circuit of the DC voltage converter usually provided between charging connection and DC/DC charging contactors can be saved.

A change of the high-voltage series line set can be omitted.

The charging device only requires a two-pole high-current plug connector (for example a two-pole 500 A plug connector) for the connection of the charging connection, while only two three-pole plug connectors for lower power (for example two three-pole 125 A plug connectors) are required for the connection of the charging unit to the power distributor unit.

Since an electrical bypass path does not have to be guided via the charging unit in charging at an 800 V charging station, the bypass switch, for example a high-voltage contactor, can be saved. The installation space can be reduced since high-current power rails are omitted. Heating of the charging unit due to usually required looping through the high-current path as a bypass through the charging unit does not occur.

The charging unit only has to be designed for lower charging powers such that the charging unit can be more compactly and lighter constructed. The charging unit as well as the switches as well as plug connectors and cables installed at the charging unit only have to be designed for the own nominal current of the charging unit.

Thereby, a conformity of the charging unit with currently known charging standards can be ensured.

The integration of the charging device in the vehicle is also simplified since the charging device only comprises a high-voltage connection at the power distributor unit as well as lower bending radii of the high-voltage lines.

Saving additional plug connectors and high-voltage contactors results in a significant cost and weight saving.

The charging device according to the invention can be advantageously employed for charging an electrical energy storage of electrically operable vehicles with usual DC charging methods or DC charging standards, like CCS type 1 or CCS type 2 (CCS=“Combined Charging System” as a standard developed in Europe), which allows charging with direct current and alternating current with type 2 plugs, CHAdeMO (“Charge de Move” as a standard developed in Japan with a charging power mostly up to 50 kW), GB/T (as a standard developed in China). Advantageously, the charging device can also be employed with future standards like ChaoJi (for CHAdeMO standard 3.0 with a charging power up to 500 kW) and megawatt charging, which either does not have to be guided via the charging unit with charging voltages at the level of the high-voltage on-board voltage, and analogously to the advantages in charging at an 800 V charging station, thus, heating of the charging unit due to usually required looping of the high-current path as a bypass through the charging unit either does not occur. Hereby, the charging device does not only currently have advantages in charging at 800 V charging stations and 400 V charging stations, but is also future-proof applicable in upcoming charging standards and therein also offers the same advantages.

By the arrangement of the interconnection of the charging unit to the DC voltage converter, in particular the new electric vehicles with a high-voltage on-board voltage of more than 500 V, for example 800 V, can be directly charged not only at DC charging stations with also the same high charging voltage, but also downward compatible via the charging unit of the charging device at charging stations with lower voltage, such as for example with 400 V.

According to an advantageous configuration of the charging device, the DC voltage converter can be formed as a step-up converter. Beneficially, a first DC voltage of 400 V can thus be converted into a second DC voltage of 800 V required for charging an energy storage with a rated voltage of 800 V.

According to an advantageous configuration of the charging device, in the first charging state, in particular in which the first DC voltage at the charging connection is greater than or equal to the rated voltage of the electrical energy storage, the first switch and the second switch can be closed and the third switch can be opened. Therein, the first DC voltage is applied between the first output and the second output of the power distributor. In this manner, the DC voltage applied to the charging connection can be directly interconnected to the outputs of the power distributor unit and thereby to an input of the energy storage.

According to an advantageous configuration of the charging device, the first electrical connection of the power distributor unit can comprise a two-pole high-current plug connector. Beneficially, only one cable with such a plug connector is thus required for connecting the charging connection to the power distributor unit.

According to an advantageous configuration of the charging device, the second electrical connection of the power distributor unit can comprise a three-pole plug connector. Thus, the charging unit can be advantageously connected to the power distributor unit via a cable with two three-pole plug connectors. Here, a two-pole plug connector and a single-pole plug connector can alternatively also be provided such that two plug connectors with once two poles and once one pole are arranged instead of an integral plug connector with three poles. Herein, the two plug connectors can then be separately connected to each other via two independent connection devices, in particular two cables, or also via a common cable, also as a harness, or a single cable then with two connection devices for the two plug connectors once with one pole and once with two poles. In a further advantageous design, the connection can also be provided as three individual plug connectors with each one single pole, but which is slightly more expensive and also more prone to failure by the higher number of plug connectors.

Advantageously, the second electrical connection of the power distributor unit and the third electrical connection of the charging unit can be complementarily designed such that the second electrical connection of the power distributor unit is directly connectable to the third electrical connection of the charging unit without connection device. At the power distributor unit, a socket can for example be directly arranged at the housing and, at the charging unit, the mating counterpart can be directly arranged at the housing as a plug such that a connection between the power distributor unit and the charging unit can be directly established via the plug-socket connection at the two housings.

Instead of a cable as the connection device between the plug connections, regardless of whether with a plug connector with three poles or with two plug connectors with once one pole and once two poles, alternatives can also be used, which can for example also be effected via power rails, thus fixed pre-formed line devices or a so-called direct connection is also possible. In case of a direct connection, a connection device between the plug connector of the charging unit and the plug connector of the power distributor unit is completely omitted and the plug connector of the charging unit is directly connected to the plug connector of the power distributor unit, thus plugged into each other. Therein, a connection device, in particular a cable, cannot only be omitted, which saves weight and cost, but also an improvement of the conductivity and reduction of failure sources can be achieved by the lower number of contacts.

According to an advantageous configuration of the charging device, a third electrical connection can be provided at the charging unit, which is connected to the second electrical connection of the power distributor unit. In particular, the third electrical connection can comprise a three-pole plug connector. Thus, the charging unit can be advantageously connected to the power distributor unit via a cable with two three-pole plug connectors.

Thus, for connecting the charging connection to the power distributor unit, only one two-pole high-current plug connector is advantageously required, and for connection of the charging unit to the power distributor unit, only two three-pole plug connectors are required, which are designed for lower nominal currents of the charging unit.

According to an advantageous configuration of the charging device, in the second charging state, the positive pole of the poles of the charging connection can represent a common reference of the first DC voltage applied to the charging connection and the second DC voltage applied to the first output and the second output of the power distributor unit. With such an advantageous interconnection, it is possible to switch the first DC voltage of 400 V to the input of the charging unit and to switch the second DC voltage of 800 V from the output of the charging unit to the outputs of the power distributor unit. Beneficially, this interconnection can be effected via an only three-pole cable. Alternatively or reinterpreted, the same also applies to the negative pole of the poles.

According to a further aspect of the invention, a method for charging an electrical energy storage of an electrically operable vehicle with a charging device as above described is proposed. Therein, the method comprises at least the following steps: comparing a maximum voltage, which the charging station can provide as a first DC voltage, to a voltage maximally required for charging the electrical energy storage as a rated voltage of the electrical energy storage.

Herein, the maximum voltage, which the charging station can provide as the first DC voltage, is normally determined in charging via a communication between the vehicle and the charging station or exchanged or requested by the vehicle and transferred by the charging station. In addition, the voltage can also be measured before closing charging contactors to ensure that a too great voltage difference is not present between the charging voltage and a pre-charge of a high-voltage intermediate circuit in order not to damage the contactors upon closing.

In the following, the first DC voltage always relates to the maximally possible voltage, which the charging station can provide, and the rated voltage relates to the maximally required voltage of the electrical energy storage, which is required for charging.

In case that the first DC voltage is greater than or equal to the rated voltage of the electrical energy storage, the method further comprises the steps: closing a first and a second switch of a power distributor unit for connecting the charging connection to a first output and a second output of the power distributor unit; switching the first DC voltage to the first output and the second output via the first and second switches; charging the electrical energy storage with the first DC voltage.

In case that the first DC voltage is less than the rated voltage of the electrical energy storage, the method further comprises the steps: closing the first switch for connecting a first pole of the charging connection to the first output of the electrical energy storage and a first output of a charging unit; opening the second switch of the power distributor unit and connecting an input of the charging unit to a second pole of the charging connection; closing a third switch of the charging unit for connecting the input of the charging unit to an input of a DC voltage converter of the charging unit; switching a second DC voltage converted by the charging unit to the first output and the second output of the power distributor unit; charging the electrical energy storage with the second DC voltage.

According to the method according to the invention, in a first charging state, in which the first DC voltage is greater than or equal to the rated voltage of the electrical energy storage, the first DC voltage applied to the charging connection can advantageously be directly interconnected to the outputs of the power distributor unit. Thereby, an energy storage electrically connected to the outputs can be charged with the first DC voltage.

Further, in a second charging state, in which the first DC voltage is less than the rated voltage of the electrical energy storage, the first DC voltage can be switched to the input of the charging unit. Further, by opening the second switch of the power distributor unit, the connection of the charging connection to the output of the power distributor unit is disconnected. In the charging unit, the first DC voltage is converted into a second higher DC voltage by a DC voltage converter, which is then switched to the outputs of the power distributor unit via the outputs of the charging unit. Thereby, an energy storage electrically connected to the outputs can be charged with the second DC voltage.

### BRIEF DESCRIPTION OF THE FIGURES

Further advantages are apparent from the following description of drawings. In the drawings, an embodiment of the invention is illustrated. The drawings, the description and the claims include numerous features in combination. The expert will also conveniently individually consider the features and combine them to reasonable further combinations.

FIG. 1 shows a system overview of the charging device for charging an electrical energy storage of an electrically operable vehicle according to an embodiment of the invention.

FIG. 2 shows a vehicle with a charging device according to the invention in a schematic representation.

FIG. 3 shows a flow diagram of a method for charging an electrical energy storage of an electrically operable vehicle according to an embodiment of the invention.

In the figures, identical or similar components are numbered with the same reference characters. The figures only show examples and are not to be understood as restrictive.

### DETAILED DESCRIPTION

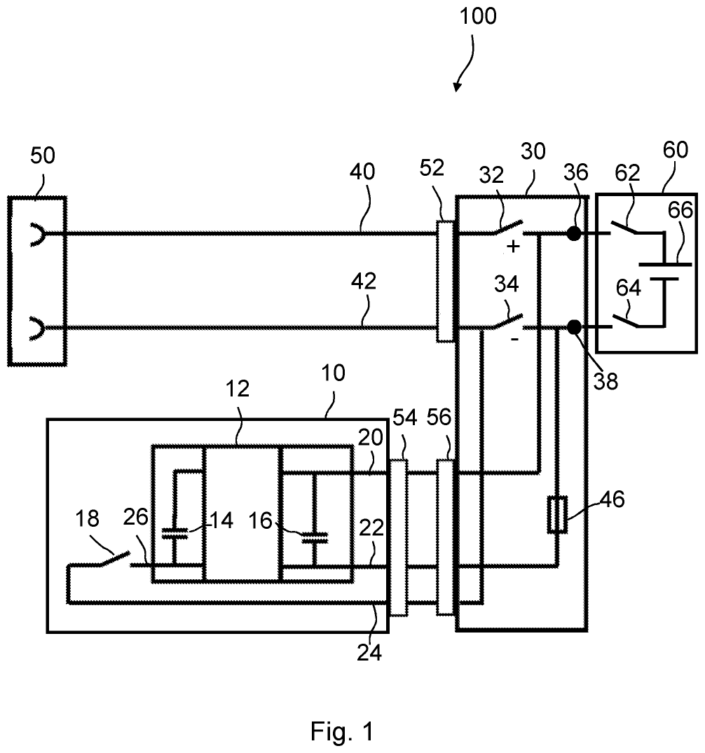

FIG. 1 shows a system overview of the charging device 100 for charging an electrical energy storage 60 of an electrically operable vehicle 200 according to an embodiment of the invention.

The charging device 100 includes a charging connection 50 for electrically connecting the charging device 100 to an external voltage supply not illustrated, a charging unit 10 for converting a first DC voltage applied to the charging connection 50 into a second DC voltage, which is intended for charging the electrical energy storage 60, as well as a power distributor unit 30 with a first and a second output 36, 38 for providing the first DC voltage applied to the charging connection 50 and/or the second DC voltage converted by the charging unit 10 to the electrical energy storage 60 connected to the outputs 36, 38.

In the embodiment illustrated in the figure, the energy storage 60 is directly connected to the outputs 36, 38 of the power distributor unit 30 and includes a series of battery cells 66, which are only schematically indicated by a battery symbol and which are connected via two contactors 62, 64 for charging.

Generally, the outputs 36, 38 of the power distributor unit 30 can be connected to further, non-illustrated components, relevant to charging, of a high-voltage intermediate circuit of a high-voltage on-board power supply of the vehicle, such as for example further switches.

The power distributor unit 30 comprises a first electrical connection 52 for the charging connection 50 and a second electrical connection 56 for the charging unit 10.

Furthermore, the power distributor unit 30 comprises switches 32, 34, by which the charging connection 50 can be switched to the first and second outputs 36, 38 by closing the switches 32, 34 in a first charging state. In the first charging state, thereby, a first DC voltage applied to the charging connection 50 is switched to the first and second outputs 36, 38 of the power distributor unit 30.

The charging unit 10 comprises a connection 54, via which an input 24 and two outputs 20, 22 of the charging unit 10 can be contacted with the connection 56 of the power distributor unit 30. The input 24 of the charging unit 10 is interconnected to a second pole 42 of the charging connection 50. A switch 18 is provided in the charging unit 10, which interconnects the input 24 of the charging unit 10 to an input 26 of a DC voltage converter 12 of the charging unit 10. The DC voltage converter 12 is formed as a step-up converter and comprises an input capacitance 14 at its input and an output capacitance 16 at its output. By the connection of the output 20 of the charging unit 10 to the output capacitance 16 and the input capacitance 14, the output 20 is also used as an input of the charging unit 10 at the same time. Here, in the embodiment, it is a galvanically coupled DC voltage converter 12 with a coupling in the upper path, thus in the plus path, with the outputs 20, 22 and the input 24 and the output 20 as a simultaneous further input.

In the first charging state, in which the first DC voltage at the charging connection 50 is in particular greater than or equal to the rated voltage of the electrical energy storage 60, the first switch 32 and the second switch 34 of the power distributor unit 30 are closed and the third switch 18 of the charging unit 10 is opened. Thereby, the first DC voltage is applied between the first output 36 and the second output 38 of the power distributor 30 and the energy storage 60 can be charged with the first DC voltage.

In a second charging state, the first output 20 of the charging unit 10 is switched to one of the outputs 36, 38 of the power distributor unit 30, to the first output 36 in the embodiment in FIG. 1. The second output 22 of the charging unit 10 is switched to the other one of the outputs 36, 38 of the power distributor unit 30, to the second output 38 in FIG. 1. As illustrated, this path can be secured with an optional fuse 46.

In the second charging state, in which the first DC voltage at the charging connection 50 is in particular less than the rated voltage of the electrical energy storage 60, the first switch 32 is closed and thereby the first output 20 of the charging unit 10 is interconnected to the first pole 40 of the charging connection 50 via the closed first switch 32 of the power distributor unit 30 as well as directly to the first output 36 of the power distributor unit 30. The second switch 34 of the power distributor unit 30 remains open.

The second output 22 of the charging unit 10 is fixedly interconnected to the second output 38 of the power distributor unit 30. Thereby, the input 24 of the charging unit 10 is connected to the second pole 42 of the charging connection 50. The third switch 18 of the charging unit 10 is closed. Thereby, the input 26 of the DC voltage converter 12 is connected to the second pole 42 of the charging connection 50.

In the second charging state, thus, the first DC voltage applied to the charging connection 50 is directly applied to the DC voltage converter 12 and can be converted into a second DC voltage by it, which is then switched to the first and second outputs 36, 38 of the power distributor unit 30. Thereby, the energy storage 60 can be charged with the second DC voltage.

Thereby, the positive one of the two poles 40, 42 of the charging connection 50, here pole 40, represents a common reference of the first DC voltage applied to the charging connection 50 and the second DC voltage applied to the first output 36 and the second output 38 of the power distributor unit 30 in the second charging state. In this manner, it is advantageously possible to perform the interconnection of the charging unit 10 to the power distributor unit 30 by means of three-pole connections 54, 56.

With the presented charging device 100 according to the invention, an electrical energy storage 60 with a rated voltage of more than 500 V, for example 800 V, can for example also be charged at a charging station with an output voltage of less than 500 V, for example 400 V.

If 800 V are available at the charging connection 50 as the first DC voltage, the first DC voltage can be directly interconnected to the outputs 36, 38 of the power distributor unit 30 in the first charging state and the energy storage 60 can be charged with high current, for example 500 A. Thereto, the first electrical connection 52 of the power distributor unit 30 comprises a two-pole high-current plug connector.

However, if only 400 V are available at the charging connection 50 as the first DC voltage, the first DC voltage is not directly interconnected, but applied to the input 26 of the DC voltage converter 12, which converts the first DC voltage of 400 V into a second DC voltage of 800 V. This second DC voltage of 800 V is then switched to the outputs 36, 38 of the power distributor unit 30 and thereby the energy storage 60 is charged. This charging operation can advantageously be performed with lower current, for example 125 A for a charging power of 50 kW, such that the two plug connectors 54, 56 between charging unit 10 and power distributor unit 30 only have to comprise three-pole plug connectors for the lower nominal current of the DC voltage converter 12.

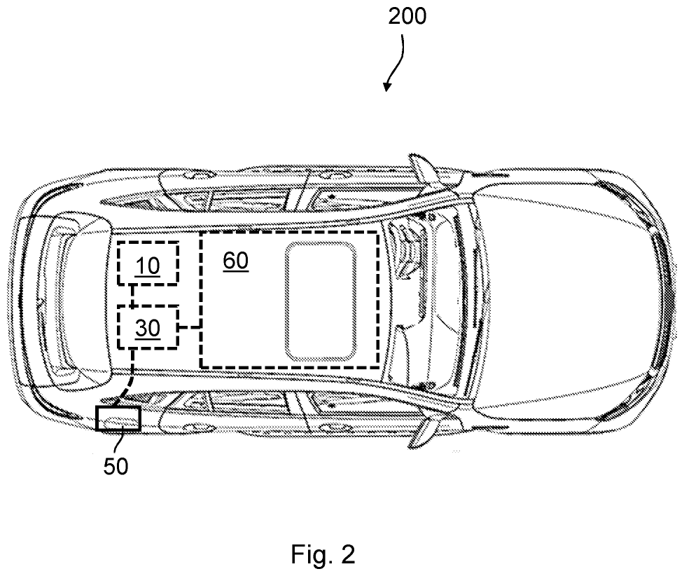

FIG. 2 shows a vehicle 200 with a charging device 100 according to the invention in a schematic representation. The vehicle 200 is illustrated in a top view. In the figure, on the side back right in the vehicle 200, the charging connection 50 is drawn, which is in turn electrically connected to the power distributor unit 30. The power distributor unit 30 comprises electrical connections to the charging unit 10 and to the electrical energy storage 60.

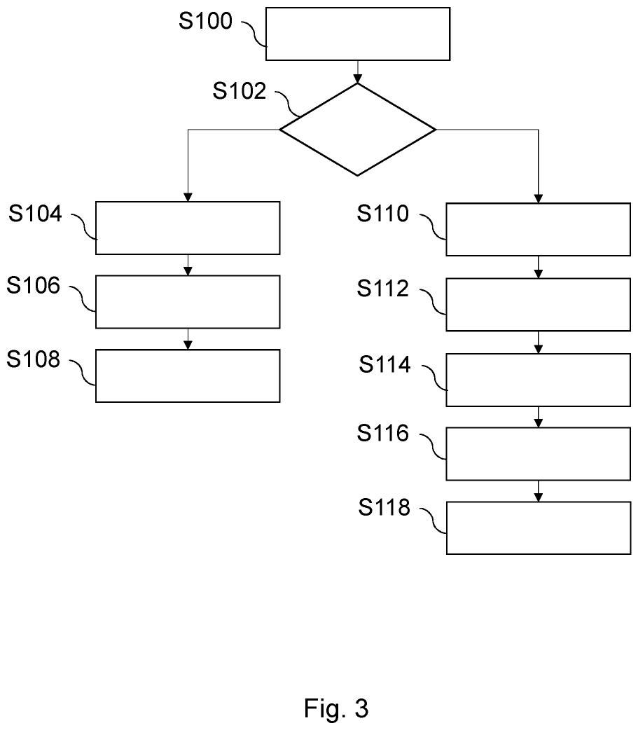

In FIG. 3, a flow diagram of a method for charging an electrical energy storage 60 of an electrically operable vehicle 200 according to an embodiment of the invention is illustrated.

The method starts in that a first DC voltage applied to the charging connection 50 is determined in step S100 and is compared to a rated voltage of the electrical energy storage 60 in step S102. The determination of the applied first DC voltage normally occurs based on a communication between the vehicle and the charging station, in which the charging station transfers the voltage maximally capable of being provided as the first DC voltage to the vehicle.

In case that the first DC voltage is greater than or equal to the rated voltage of the electrical energy storage 60, thus, for example the first DC voltage available at the charging connection 50 is 800 V at a rated voltage of the energy storage 60 of also 800 V, the first and the second switch 32, 34 of the power distributor unit 30 are closed in step S104 for connecting the charging connection 50 to the first output 36 and the second output 38 of the power distributor unit 30.

Thereby, the first DC voltage is switched to the first output 36 and the second output 38 via the first and second switches 32, 34 in step S106.

Thereby, the electrical energy storage 60 can be charged with the first DC voltage in step S108.

In case that the available first DC voltage is less than the rated voltage of the electrical energy storage 60, thus, for example the first DC voltage available at the charging connection 50 is 400 V at a rated voltage of the energy storage of 800 V, the first switch 32 is closed in step S110 for connecting the first pole 40 of the charging connection 50 to the first output 36 of the electrical energy storage and to the first output 20 of the charging unit 10.

In step S112, the second switch 34 of the power distributor unit 30 remains opened. The input 24 of the charging unit 10 is connected to the second pole 42 of the charging connection 50. If the second switch 34 should have been closed by another step in advance of this method, the closed switch 34 is opened in step S112.

In step S114, the third switch 18 of the charging unit 10 is closed for connecting the input 24 of the charging unit 10 to the input 26 of the DC voltage converter 12 of the charging unit 10.

Thereby, the second DC voltage converted by the charging unit 10 is switched to the first output 36 and the second output 38 of the power distributor unit 30 in step S116.

Thereby, the electrical energy storage 60 can be charged with the second DC voltage in step S118.

### LIST OF REFERENCE CHARACTERS

10 Charging unit
12 DC voltage converter
14 input capacitance
16 output capacitance
18 switch
20 first output charging unit
22 second output charging unit
24 input charging unit
26 input DC voltage converter
30 power distributor unit
32 switch
34 switch
36 first output power distributor unit
38 second output power distributor unit
40 first pole
42 second pole
46 fuse
50 charging connection
52 high-current plug connector
54 plug connector
56 plug connector
60 energy storage
62 switch
64 switch
66 battery cells
100 charging device
200 vehicle

1.-9. (canceled)

10. A charging device for charging an electrical energy storage of an electrically operable vehicle, comprising:
a charging connection for electrically connecting the charging device to an external voltage supply;
a charging unit for converting a first DC voltage applied to the charging connection into a second DC voltage, which is intended for charging the electrical energy storage; and
a power distributor unit with a first output and a second output for providing the first DC voltage applied to the charging connection and/or the second DC voltage converted by the charging unit to the energy storage electrically connected to the outputs, the power distributor unit including,
a first electrical connection for the charging connection,
a second electrical connection for the charging unit, and
first and second switches, by which the charging connection is switched to the first and second outputs in a first charging state, and in a second charging state, a first output of the charging unit is switched to one of the first and second outputs of the power distributor unit and a second output of the charging unit is switched to another one of the first and second outputs of the power distributor unit,
wherein in the second charging state, in particular in which the first DC voltage at the charging connection is less than a rated voltage of the electrical energy storage,
the first output of the charging unit is interconnected to a first pole of the charging connection via the first switch of the power distributor unit as well as directly to the first output of the power distributor unit,
wherein by a connection of the first output of the charging unit to an output capacitance of the charging unit and an input capacitance of the charging unit,
the first output of the charging unit is also used as an input of the charging unit at the same time,
the second output of the charging unit is interconnected to the second output of the power distributor unit, and
the input of the charging unit is interconnected to a second pole of the charging connection,
wherein a third switch is provided in the charging unit, which interconnects the input of the charging unit to an input of a DC voltage converter of the charging unit, and
wherein the DC voltage converter is formed as a step-up converter.

11. The charging device according to claim 10, wherein in the first charging state, in particular in which the first DC voltage at the charging connection is greater than or equal to the rated voltage of the electrical energy storage, the first switch and the second switch are closed and the third switch is opened, wherein the first DC voltage is applied between the first output and the second output of the power distributor.

12. The charging device according to claim 10, wherein the first electrical connection of the power distributor unit comprises a two-pole high-current plug connector.

13. The charging device according to claim 10, wherein the second electrical connection of the power distributor unit comprises a three-pole plug connector or two plug connectors with once one pole and once two poles.

14. The charging device according to claim 10, wherein a third electrical connection is provided at the charging unit, which is connected to the second electrical connection of the power distributor unit, in particular wherein the third electrical connection comprises a three-pole plug connector or two plug connectors with once one pole and once two poles.

15. The charging device according to claim 14, wherein the second electrical connection of the power distributor unit and the third electrical connection of the charging unit are complementarily designed such that the second electrical connection of the power distributor unit is directly connectable to the third electrical connection of the charging unit without connection device.

16. The charging device according to claim 10, wherein in the second charging state, the positive pole of the poles of the charging connection represents a common reference of the first DC voltage applied to the charging connection and of the second DC voltage applied to the first output and the second output of the power distributor unit.

17. A method for charging an electrical energy storage of an electrically operable vehicle, including a charging device according to claim 10, comprising:
comparing a first DC voltage capable of being provided at a charging connection to a rated voltage of the electrical energy storage;
in case that the first DC voltage is greater than or equal to the rated voltage of the electrical energy storage,
closing a first switch and a second switch of a power distributor unit for connecting the charging connection to a first output and a second output of the power distributor unit,
switching the first DC voltage to the first output and the second output via the first switch and the second switch, and
charging the electrical energy storage with the first DC voltage; and
in case that the first DC voltage is less than the rated voltage of the electrical energy storage,
closing the first switch for connecting a first pole of the charging connection to the first output of the electrical energy storage and to a first output of a charging unit,
keeping open or opening the second switch of the power distributor unit and connecting an input of the charging unit to a second pole of the charging connection,
closing a third switch of the charging unit for connecting the input of the charging unit to an input of a DC voltage converter, formed as a step-up converter, of the charging unit,
switching a second DC voltage converted by the charging unit to the first output and the second output of the power distributor unit, and
charging the electrical energy storage with the second DC voltage.
